(19) United States
(12) Patent Application Publication
(10) Pub. No.: US 2026/0141576 A1
(43) Pub. Date: May 21, 2026

(54) IMAGE GENERATION METHOD, ELECTRONIC DEVICE AND STORAGE MEDIUM

(71) Applicant: Beijing Zitiao Network Technology Co., Ltd., Beijing (CN)

(72) Inventors: Haokun CHEN, Beijing (CN); Tingwei GAO, Beijing (CN); Jie SHAO, Beijing (CN)

(21) Appl. No.: 19/350,989

(22) Filed: Oct. 6, 2025

(30) Foreign Application Priority Data
Oct. 10, 2024 (CN) 202411413179.3

(51) Int. Cl. G06T 11/00; G06F 40/186; G06F 40/30

(52) U.S. Cl. CPC G06T 11/00; G06F 40/186; G06F 40/30; G06T 2200/24

(57) ABSTRACT

The present disclosure relates to an image generation method, an electronic device, and a storage medium, the method includes: obtaining an original text; determining a target extension template including a plurality of extension aspects; extending the original text according to an extension aspect included in the extension template to obtain an extended text; generating a target image based on the extended text.

### CROSS-REFERENCE TO RELATED APPLICATION(S)

The present application claims the priority of Chinese Patent Application No. 202411413179.3, filed on Oct. 10, 2024, and the disclosure of the above-mentioned Chinese Patent Application is incorporated herein by reference as a part of the present application.

### TECHNICAL FIELD

The present disclosure relates to the technical field of artificial intelligence, and more particularly to an image generation method and apparatus, an electronic device, and a storage medium.

### BACKGROUND

In the digital age, image generation technology, as an important breakthrough in the field of artificial intelligence, has greatly enriched users'content creation experience and brought unprecedented innovation power to many industries. Nevertheless, this technology still has certain limitations. In the current technical field, when generating an image, the common text-to-image generation model mainly relies on the text directly input by a user as the basis for generating the image. In practical applications, due to the uneven quality of text provided by users, there may be problems such as unclear expression, missing or inaccurate key information, etc., which will directly affect the quality and accuracy of the image generated by the image generation model.

### SUMMARY

The present disclosure provides an image generation method and apparatus, an electronic device, and a storage medium.

The present disclosure provides an image generation method including: obtaining an original text;
determining a target extension template including a plurality of extension aspects;
extending the original text according to the plurality of extension aspects included in the target extension template to obtain an extended text;
generating a target image based on the extended text.

The present disclosure further provides an image generation apparatus, including:
an obtaining module, configured to obtain an original text;
a template determination module, configured to determine a target extension template, wherein the target extension template includes a plurality of extension aspects;
an extension module, configured to extend the original text according to the plurality of extension aspects included in the target extension template to obtain an extended text; and
an image generation module, configured to generate a target image based on the extended text.

The present disclosure further provides an electronic device, the electronic device includes:
one or more processor;
a storage apparatus, configured for storing one or more programs;
wherein the one or more processor implements the above-mentioned image generation method when the one or more programs are executed by the one or more processor.

The present disclosure further provides a computer-readable storage medium having a computer program stored thereon, the computer program, when executed by a processor, implements the above-mentioned image generation method.

### BRIEF DESCRIPTION OF DRAWINGS

The accompanying drawings herein, which are incorporated into and constitute a part of the specification, illustrate embodiments consistent with the present disclosure and, together with the specification, serve to explain the principles of the present disclosure.

In order to more clearly explain the technical solutions in the embodiments of the present disclosure or the prior art, the drawings that need to be used in the description of the embodiments or the prior art will be briefly introduced below, and it is obvious that other drawings can be obtained from these drawings without making creative labor for those skilled in the art.

FIG. 1 is a flowchart of an image generation method according to an embodiment of the present disclosure.

FIG. 2 and FIG. 3 are schematic diagrams illustrating two types electronic device display interfaces provided by embodiments of the present disclosure;

FIG. 4 is a schematic structural diagram of an image generation apparatus according to an embodiment of the present disclosure.

FIG. 5 is a schematic structural diagram of an electronic device according to an embodiment of the present disclosure.

### DETAILED DESCRIPTION

In order to enable a clearer understanding of the above-described objects, features, and advantages of the present disclosure, solutions of the present disclosure will be further described below. It is to be noted that the embodiments of the present disclosure and the features in the embodiments may be combined with each other without conflict.

Numerous specific details are set forth in the following description to facilitate a full understanding of the disclosure, but the disclosure may be implemented in other ways than those described herein; Obviously, the embodiments in the specification are only some of, but not all of, the embodiments of the present disclosure.

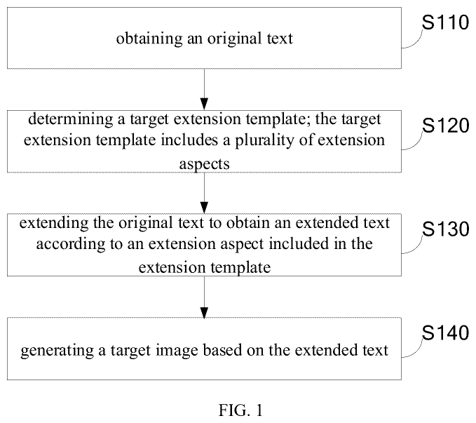

FIG. 1 is a flowchart of an image generation method provided by an embodiment of the present disclosure, which can be applied to a case of generating an image in a client, and the method may be executed by an image generation apparatus, which may be implemented by software and/or hardware, and may be configured in an electronic device, such as a terminal, specifically including but not limited to a smartphone, a handheld computer, a tablet computer, a wearable device with display screen, a desktop computer, a notebook computer, an all-in-one machine, a smart home device, or the like. Alternatively, the present embodiment may be applied to a case where image generation is performed in a server, and the method may be performed by an image generation apparatus, which may be implemented by software and/or hardware, and may be configured in an electronic device, such as a server.

As shown in FIG. 1, the method may specifically include:
S110: obtaining an original text.

The original text may be, for example, a text input by the user.
S120: determining a target extension template; the target extension template includes a plurality of extension aspects.

The target extension template may be, for example, a template for extension of the original text, which indicates a specific direction of extension by means of an extension aspect. Illustratively, for a certain original text, the target extension template determined for the original text includes three extension aspects which are main body description, background description, and image style, respectively. Under the guidance of the target extension template, the original text can be extended from these three extension aspects subsequently.

There are many methods to implement this step, and the present application is not limited thereto. Illustratively, in an embodiment, a method of implementing the present step may include: determining a target usage scene information; and determining a target extension template based on the target usage scene information.

The target usage scene information may be, for example, a usage scenario of the image currently generated by the user. Illustratively, the target usage scene may be, for example, a promotional scene for promoting a certain object, a scene as a social media for sharing information, a scene as a photographic work, a scene as a game screen, a scene that forms an image having a specific style (such as a cartoon style, a watercolor style, an oil painting style, a clay style, or the like), or the like.

“Determining a target extension template based on the target usage scene information” may, for example, include: providing a plurality of candidate extension templates; different candidate extension templates correspond to different usage scene information; determining the target extension template among the plurality of candidate extension templates according to the target scene information. Wherein, the candidate extension templates are extension templates pre-designed according to specific usage scenes. Since the specific usage scenarios are different, the candidate extension templates are customized according to the specific usage scenes, and therefore can better serve the usage requirements of the specific scenes.

“Determining the target extension template among the plurality of candidate extension templates according to the target scene information” can make the used target extension template match the usage scenario desired by the user, thereby improving the quality and accuracy of subsequent image generation.
S130, extending the original text to obtain an extended text according to an extension aspect included in the extension template.

Extending the original text refers to supplementing and improving the information of the original text. After the original text is extended, the information amount of the extended text that is obtained is greater than the information amount of the original text.

There is a plurality of methods to implement this step, and the present application is not limited thereto. Illustratively, in an embodiment, the extension aspects each have a preset lexical database corresponding thereto; The implementation method of this step may include: for any one of the extension aspects, extracting a first reference text related to the extension aspect from the original text; determining a second reference text related to the extension aspect from the preset lexical database; performing extension based on the first reference text and/or the second reference text to obtain description information corresponding to the extension aspect; organizing the description information corresponding to the respective extension aspects to obtain the extended text.

Optionally, extracting the first reference text related to the extension aspect from the original text may include: performing semantic understanding on the original text to obtain a semantic understanding result; extracting the first reference text related to the extension aspect from the original text based on the semantic understanding result.

Performing semantic understanding on the original text can be specifically realized by using a model with semantic understanding function. The model with semantic understanding function can comprehensively and deeply analyze the original text, clarify the overall meaning of the original text and the meaning of each word in the original text, and can understand the relationship between entities in the original text. By performing semantic understanding on the original text, electronic device can understand which character or phrase in the original text corresponds to a specific extension aspect in the target extension template, and the phrase is the first reference text related to the extension aspect.

The extension aspect having a preset lexical database corresponding thereto refers to that, for a certain extension aspect, the phrase in the preset lexical database corresponding to the extension aspect is a phrase that can describe the extension aspect. For example, if a certain extension aspect is image style, the phrases in the lexical database corresponding to the extension aspect may include professional photography, tranquil, majestic, high resolution, focused subject, deep depth of field, 8K, 4K, realistic, and the like. “Determining the second reference text related to the extension aspect from the preset lexical database” may be, for example, selecting one or more phrases from the preset lexical database corresponding to the extension aspect as the second reference text.

“Performing extension based on the first reference text and/or the second reference text to obtain description information corresponding to the extension aspect” may include, for example, for any extension aspect, if a first reference text related to the extension aspect is obtained, using the first reference text as the description information corresponding to the extension aspect. If a first reference text related to the extension aspect is not obtained, the second reference text is used as the description information corresponding to the extension aspect. Alternatively, for any extension aspect, both the first reference text and the second reference text are used as description information corresponding to the extension aspect.

“Organizing the description information corresponding to the respective extension aspects to obtain the extended text” may include, for example, aggregating description information corresponding to the respective extension aspects, and the aggregated result is the extended text. Optionally, in the process of aggregation, necessary grammatical correction, supplementation and improvement can be made to the respective description information, such that the description information is coherent and smooth.

In some scenarios, optionally, organizing the description information corresponding to the respective extension aspects to obtain the extended text may include organizing the description information corresponding to the respective extension aspects according to a preset arrangement order to obtain the extended text.

Preset arrangement order is used to define the sequential order of arrangement of the description information corresponding to the respective extension aspects in the extended text.

By organizing the description information corresponding to the respective extension aspects according to preset arrangement order, to obtain the extended text, the purpose thereof is to unify the sequential order of arrangement of the description information corresponding to the respective extension aspects in the extended text, so as to improve the accuracy of image generation when target image is generated by image generation model subsequently.
S140: generating a target image based on the extended text.

There are a plurality of methods to implement this step, which is not limited in the present application. Exemplarily, a method of implementing this step may include: inputting the extended text into an image generation model (e.g., a text-to-image model or an image-to-image model), so that the image generation model generates the target image.

For example, if the original text is “snow mountain and glacier”, the target extension template includes four extension aspects which are “subject position description”, “background description”, “image style” and “negative phrase”, respectively. Based on the target extension template, the description information corresponding to the extension aspect of “subject position description” includes “placed on a wooden platform”, the description information corresponding to the extension aspect of “background description” includes “the background shows tranquil snow mountain and glacier”, the description information corresponding to the extension aspect of “image style” includes “professional photography, tranquil, majestic, high resolution, focused subject, deep depth of field, 8K, realistic”, and the description information corresponding to the extension aspect of “negative phrase” includes “people, beach items, summer theme”. Subsequently, this description information is summarized and the extended text is obtained.

In the above technical solution, through setting and determining the target extension template, the target extension template includes a plurality of extension aspects; the original text is extended according to the extension aspects included in the extension template to obtain the extended text; and the target image is generated based on the extended text. The essence thereof is to extend and optimize the original text provided by users to improve the quality of the original text, and further improve the quality and accuracy of the final generated image.

In the above technical solution, optionally, S120 may include: displaying an image generation information configuration page, wherein the image generation information configuration page includes image generation model labels, and different image generation model labels correspond to different image generation models, and any image generation model has its corresponding usage scene information; in response to a selection operation of selecting a target image generation model on the image generation information configuration page, using the usage scene information corresponding to the target image generation model as the target usage scene information; and determining the target extension template based on the target usage scene information. S140 may include: inputting the extended text into the target image generation model to obtain the target image.

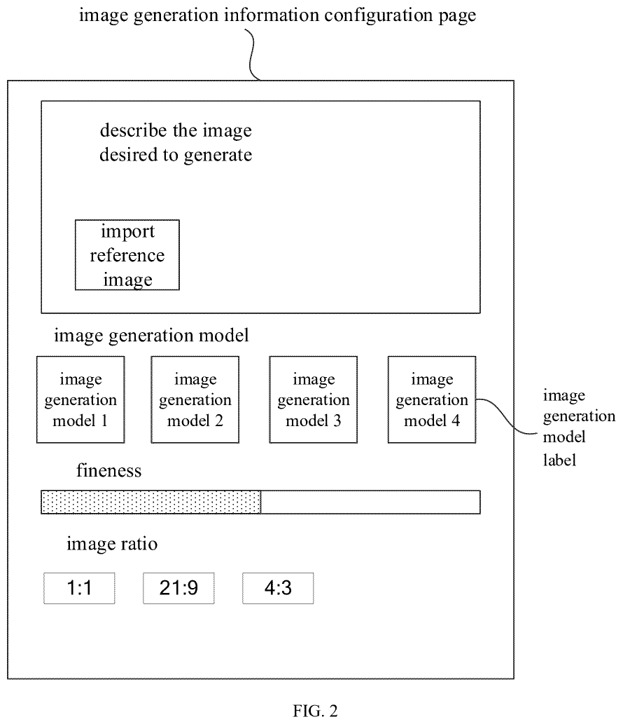

The image generation information configuration page may be, for example, a page for configuring an input information of image generation models. Illustratively, referring to FIG. 2, in the image generation information configuration page, image generation prompt information, image generation model, fineness, image ratio, and the like may be configured.

The image generation model label includes information used for distinguishing one image generation model from other image generation models. Exemplarily, the image generation model label may include icon, name, version number, serial number, etc. of the image generation model.

The selection operation of selecting a target image generation model on the image generation information configuration page may be, for example, user's operation of selecting a certain image generation model label on the image generation information configuration page, or the like. The image generation model corresponding to the image generation model label selected by the used is the target image generation model. The selection operation may be, for example, a click operation or slide operation, or the like.

Illustratively, referring to FIG. 2, the image generation information configuration page includes four image generation model labels in total, the four image generation model labels respectively represent four different image generation models. And image generation model 1 corresponds to usage scene information 1, image generation model 2 corresponds to usage scene information 2, image generation model 3 corresponds to usage scene information 3, and image generation model 4 corresponds to usage scene information 4. If the user clicks on the label of image generation model 2, usage scene information 2 will be used as the target scene information, and the original text is extended subsequently using the extension template corresponding to the target scene information.

In practice, the quality of the original text input by the user is poor, and the target usage scene information may not be accurately determined only based on the original text. Such a configuration is to further confirm the target usage scene information with the aid of the image generation model selected by the user, which can improve the accuracy of determination of the target usage scene information, thereby improving the quality of the subsequently generated image.

In another embodiment, optionally, S120 may include: displaying image generation room selection page which includes image generation room labels, wherein different image generation rooms correspond to different usage scene information; in response to a selection operation of selecting a target image generation room on the image generation room selection page, displaying image generation prompt information configuration page corresponding to the target image generation room; using the usage scene information corresponding to the target image generation room as the target usage scene information; determining the target extension template based on the target usage scene information. S140 may include: generating a target image based on the extended text in the target image generation room.

The room may be, for example, a space for image generation. Different rooms are set differently according to different usage scenes. Each image generation room has a corresponding image generation prompt information configuration page. In the image generation prompt information configuration page corresponding to each image generation room, the input information of the image generation model can be configured. However, since the setting of different image generation rooms is determined according to the usage scenes, in practice, the image generation models that can be used by different image generation rooms are different.

The image generation room label may be, for example, information that distinguishes one image generation room from other image generation rooms. Exemplarily, the image generation room label may include the name, serial number, or usage scene description information of the image generation room.

The selection operation of selecting a target image generation room on the image generation room selection page may be, for example, a user's selection operation of selecting a certain image generation room label on the image generation room selection page. The image generation room corresponding to the image generation room label selected by the user is the target image generation room. The selection operation may be, for example, a click operation or sliding, or the like.

Exemplarily, referring to FIG. 3, the image generation room selection page includes three image generation room labels, wherein image generation room 1 is used to meet the requirement of the generated image being used as a poster, image generation room 2 is used to meet the requirement that the generated image has a clay style, and image generation room 3 is used to meet the requirement that the generated image has an oil painting style. If the user selects the image generation room 2, the image generation prompt information configuration page corresponding to the image generation room 2 is displayed, and clay effect is used as the target usage scene information. Subsequently, the original text is extended by using an extension template corresponding to the target usage scene information.

Similarly, in practice, the quality of the original text input by the user is poor, and the target usage scene information may not be accurately determined only based on the original text. In this way, the image generation room is used to further deduce the target usage scene information, which can improve the accuracy of determination of the target usage scene information, thereby improving the quality of the subsequently generated image.

On the basis of the above technical solution, optionally, S130 may include: displaying the description information corresponding to the extension aspect; in response to a modification instruction to modify the description information corresponding to the extension aspect, updating the extended text based on the description information corresponding to the extension aspect that has been modified according to the modification instruction; S140 may include: generating a target image based on the extended text that has been updated.

The modification instruction to modify the description information corresponding to the extension aspect may be, for example, an instruction generated upon the user modifying the description information corresponding to one or some extension aspects. Since the extended text can be regarded as a result obtained by organizing and splicing the description information corresponding to a plurality of extension aspects, when the description information corresponding to part or all of the extension aspects is modified, the description information corresponding to the extension aspects in the extended text before modification is replaced by the modified description information corresponding to the extension aspects, so as to obtain the updated extended text.

In some scenes, updating the extended text further includes performing grammatical correction, improvement, and optimization on the extended text generated after the replacement operation.

In this way, on one hand, displaying the description information corresponding to the extension aspects can help users learn how to improve the input quality of the original text; on the other hand, it allows users to modify the prompt information input to the image generation model more effectively according to their own needs, thereby improving the quality and accuracy of image generation.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It should be noted that the above-described method embodiments are described as a series of combinations of operations for simplicity of description, but those skilled in the art should recognize that the present disclosure is not limited by the described sequence of operations, because according to the present disclosure, some steps may be performed in other sequences or performed simultaneously. Secondly, those skilled in the art should also understand that, the embodiments described in the specification are all preferred embodiments, and the acts and modules involved therein are not necessarily essential for the present invention.

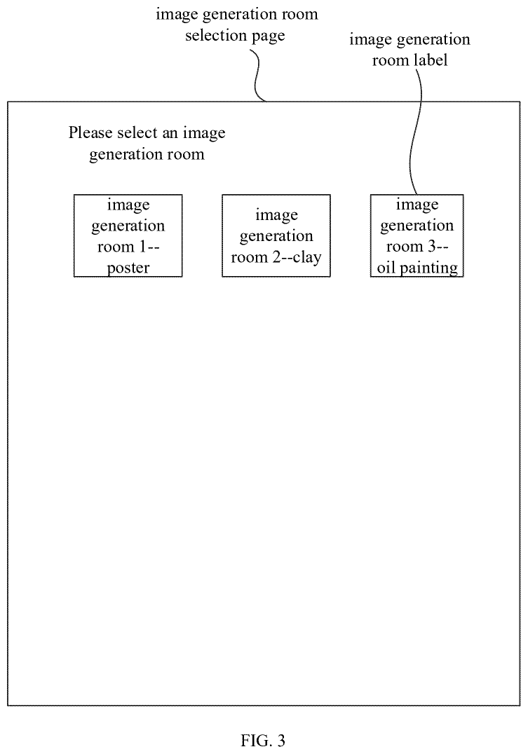

FIG. 4 is a schematic structural diagram of an image generation apparatus according to an embodiment of the present disclosure. The image generation apparatus provided by the embodiment of the present disclosure may be configured in a client or may be configured in a server. Referring to FIG. 4, the image generation apparatus specifically includes:
an obtaining module 310, configured for obtaining an original text;
a template determination module 320, configured for determining a target extension template which comprises a plurality of extension aspects;
an extension module 330, configured to extend the original text according to the extension aspect included in the extension template to obtain an extended text;
image generation module 340, configured for generating a target image based on the extended text.

Further, the template determination module 320 is configured for:
determining target usage scene information;
determining the target extension template based on the target usage scene information.

Further, the template determination module 320 is configured for:
displaying an image generation information configuration page, wherein the image generation information configuration page includes image generation model labels, and different image generation model labels correspond to different image generation models, and the image generation model has its corresponding usage scene information; in response to a selection operation of selecting a target image generation model on the image generation information configuration page, using the usage scene information corresponding to the target image generation model as the target usage scene information;
the image generation module 340 is configured for: inputting the extended text into the target image generation model to obtain the target image.

Further, the template determination module 320 is configured for:
displaying image generation room selection page which includes image generation room labels, wherein different image generation rooms correspond to different usage scene information;
in response to a selection operation of selecting a target image generation room on the image generation room selection page, displaying image generation prompt information configuration page corresponding to the target image generation room;
using the usage scene information corresponding to the target image generation room as the target usage scene information;
the image generation module 340 is configured for: generating a target image based on the extended text in the target image generation room.

Further, the extension aspect has a preset lexical database corresponding thereto; the extension module 330 is configured for:
for any one of the extension aspects, extracting a first reference text related to the extension aspect from the original text; determining a second reference text related to the extension aspect from the preset lexical database; performing extension based on the first reference text and/or the second reference text to obtain description information corresponding to the extension aspect;
organizing the description information corresponding to the respective extension aspects to obtain the extended text.

Further, the extension module 330 is configured for:
performing semantic understanding on the original text to obtain a semantic understanding result;
extracting the first reference text related to the extension aspect from the original text based on the semantic understanding result.

Further, the extension module 330 is configured for:
organizing the description information corresponding to the respective extension aspects according to a preset arrangement order to obtain the extended text.

Further, the apparatus further includes a correction module configured for:
displaying description information corresponding to the extension aspect;
in response to a modification instruction to modify the description information corresponding to the extension aspect, updating the extended text based on the description information corresponding to the extension aspect that has been modified according to the modification instruction;
the image generation module 340 is configured for generating a target image based on the extended text that has been updated.

The image generation apparatus provided by the embodiment of the present disclosure can execute the steps executed by client or server in the image generation method provided by the method embodiments of the present disclosure, and has the execution steps and beneficial effects, which will not be repeated herein.

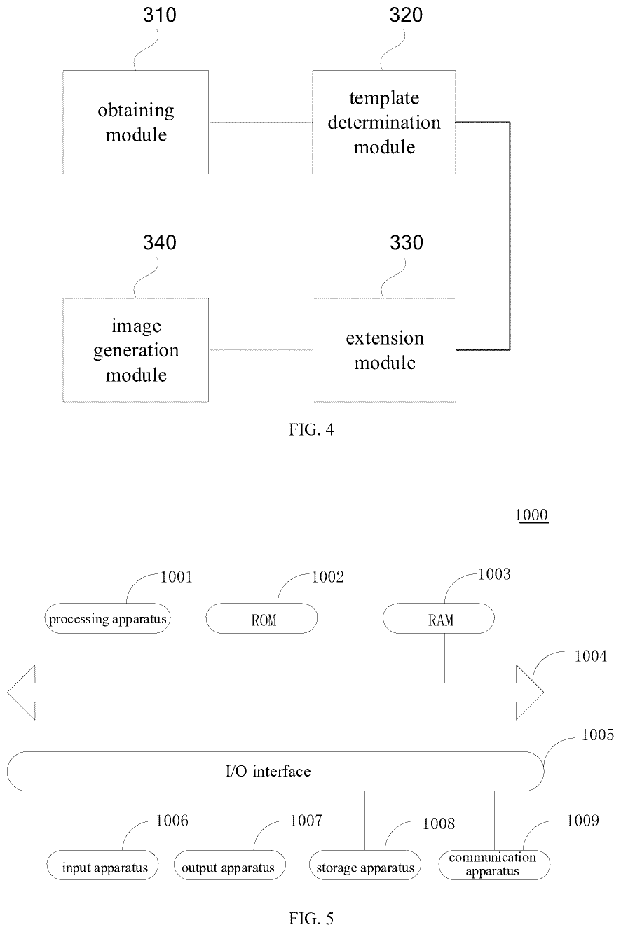

FIG. 5 is a schematic structural diagram of an electronic device according to an embodiment of the present disclosure. Referring to FIG. 5, which illustrates a schematic structural diagram of an electronic device 1000 suitable for implementing some embodiments of the present disclosure. The electronic device 1000 in the embodiment of the present disclosure may include but is not limited to, a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and a fixed terminal such as a digital TV, a desktop computer, a smart home device, or the like. The electronic device illustrated in FIG. 5 is merely an example, and should not pose any limitation to the functions and the range of use of the embodiments of the present disclosure.

As illustrated in FIG. 5, the electronic device 1000 may include a processing apparatus 1001 (e.g., a central processing unit, a graphics processing unit, etc.), which can perform various suitable actions and processing according to a program stored in a read-only memory (ROM) 1002 or a program loaded from a storage apparatus 1008 into a random-access memory (RAM) 1003. The RAM 1003 further stores various programs and data required for operations of the electronic device 1000. The processing apparatus 1001, the ROM 1002, and the RAM 1003 are interconnected by means of a bus 1004. An input/output (I/O) interface 1005 is also connected to the bus 1004.

Usually, the following apparatus may be connected to the I/O interface 1005: an input apparatus 1006 including, for example, a touch screen, a touch pad, a keyboard, a mouse, a camera, a microphone, an accelerometer, a gyroscope, or the like; an output apparatus 1007 including, for example, a liquid crystal display (LCD), a loudspeaker, a vibrator, or the like; a storage apparatus 1008 including, for example, a magnetic tape, a hard disk, or the like; and a communication apparatus 1009. The communication apparatus 1009 may allow the electronic device 1000 to be in wireless or wired communication with other devices to exchange information. While FIG. 5 illustrates the electronic device 1000 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts, thereby implementing the above-described image generation method. In such embodiments, the computer program may be downloaded online through the communication apparatus 1009 and installed, or may be installed from the storage apparatus 1008, or may be installed from the ROM 1002. When the computer program is executed by the processing apparatus 1001, the above-mentioned functions defined in the methods of embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) or the like, or any appropriate combination thereof.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: obtain an original text; determine a target extension template, wherein the target extension template includes a plurality of extension aspects; extend the original text to obtain an extended text according to an extension aspect included in the extension template; generate a target image based on the extended text.

Optionally, when one or more of the above programs are executed by the electronic device, the electronic device can also perform the other steps described in the above embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, the present disclosure provides an electronic device, including:
one or more processor;
a memory for storing one or more programs;
when the one or more programs are executed by the one or more processor, the one or more processor implements any one of the image generation methods as provided in the present disclosure.

According to one or more embodiments of the present disclosure, the present disclosure provides a computer-readable storage medium having a computer program stored thereon, the program, when executed by a processor, executes any one of the image generation methods as described in the present disclosure.

Embodiments of the present disclosure further provide a computer program product, the computer program product includes computer programs or instructions, and the computer programs or instructions, when executed by a processor, executes the image generation methods as described above.

It should be noted that, herein, relational terms such as “first” and “second” are used merely to distinguish one entity or operation from another entity or operation, and do not necessarily require or imply any such actual relationship or order between the entities or operations. Moreover, the terms “comprise”, “include”, “contain” or any other variation thereof are intended to encompass a non-exclusive inclusion, such that a process, method, article, or device that includes a series of elements includes not only those elements, but also other elements that are not explicitly listed, or elements inherent to such a process, method, article, or device. Without further limitation, an element defined by the statement “comprising a” “including a” does not preclude the presence of additional identical elements in a process, method, article, or device including the element.

The foregoing is merely a specific embodiment of the present disclosure to enable those skilled in the art to understand or implement the present disclosure. Various modifications to these embodiments will be apparent to those skilled in the art, and the general principles defined herein may be implemented in other embodiments without departing from the spirit or scope of the present disclosure. Accordingly, the present disclosure is not limited to the embodiments described herein, but complies with the widest scope consistent with the principles and novel features disclosed herein.

1. An image generation method, comprising:
obtaining an original text;
determining a target extension template, wherein the target extension template comprises a plurality of extension aspects;
extending the original text according to the plurality of extension aspects included in the target extension template to obtain an extended text; and
generating a target image based on the extended text.

2. The image generation method according to claim 1, wherein determining the target extension template comprises:
determining target usage scene information; and
determining the target extension template based on the target usage scene information.

3. The image generation method according to claim 2, wherein determining the target usage scene information comprises:
displaying an image generation information configuration page, wherein the image generation information configuration page comprises image generation model labels, and different image generation model labels correspond to different image generation models, each image generation model has corresponding usage scene information; and
in response to a selection operation for a target image generation model on the image generation information configuration page, determining usage scene information corresponding to the target image generation model as the target usage scene information;
wherein generating the target image based on the extended text comprises: inputting the extended text into the target image generation model to obtain the target image.

4. The image generation method according to claim 2, wherein determining the target usage scene information comprises:
displaying an image generation room selection page, wherein the image generation room selection page comprises image generation room labels, and different image generation rooms correspond to different usage scene information;
in response to a selection operation for a target image generation room on the image generation room selection page, displaying an image generation prompt information configuration page corresponding to the target image generation room; and
determining usage scene information corresponding to the target image generation room as the target usage scene information;
wherein generating the target image based on the extended text comprises: generating the target image based on the extended text in the target image generation room.

5. The image generation method according to claim 1, wherein each of the plurality of extension aspects has a corresponding preset lexical database; and extending the original text according to the plurality of extension aspects included in the target extension template to obtain the extended text, comprises:
for an extension aspect of the plurality of extension aspects, extracting a first reference text related to the extension aspect from the original text; determining a second reference text related to the extension aspect from the preset lexical database; and performing extension based on the first reference text and/or the second reference text to obtain description information corresponding to the extension aspect; and
organizing description information corresponding to respective extension aspects to obtain the extended text.

6. The image generation method according to claim 5, wherein extracting the first reference text related to the extension aspect from the original text comprises:
performing semantic understanding on the original text to obtain a semantic understanding result; and
extracting the first reference text related to the extension aspect from the original text based on the semantic understanding result.

7. The image generation method according to claim 5, wherein organizing the description information corresponding to the respective extension aspects to obtain the extended text comprises:
organizing the description information corresponding to the respective extension aspects according to a preset arrangement order to obtain the extended text.

8. The image generation method according to claim 5, further comprising:
displaying description information corresponding to the extension aspect; and
in response to a modification instruction to modify the description information corresponding to the extension aspect, updating the extended text based on description information corresponding to the extension aspect that has been modified according to the modification instruction;
wherein generating the target image based on the extended text comprises:
generating the target image based on the extended text that has been updated.

9. An electronic device, comprising:
one or more processor;
a storage apparatus, configured for storing one or more programs;
wherein the one or more processor implements an image generation method when the one or more programs are executed by the one or more processor, and the image generation method comprises:
obtaining an original text;
determining a target extension template, wherein the target extension template comprises a plurality of extension aspects;
extending the original text according to the plurality of extension aspects included in the target extension template to obtain an extended text; and
generating a target image based on the extended text.

10. The electronic device according to claim 9, wherein determining the target extension template comprises:
determining target usage scene information; and
determining the target extension template based on the target usage scene information.

11. The electronic device according to claim 10, wherein determining the target usage scene information comprises:
displaying an image generation information configuration page, wherein the image generation information configuration page comprises image generation model labels, and different image generation model labels correspond to different image generation models, each image generation model has corresponding usage scene information; and
in response to a selection operation for a target image generation model on the image generation information configuration page, determining usage scene information corresponding to the target image generation model as the target usage scene information;
wherein generating the target image based on the extended text comprises: inputting the extended text into the target image generation model to obtain the target image.

12. The electronic device according to claim 10, wherein determining the target usage scene information comprises:
displaying an image generation room selection page, wherein the image generation room selection page comprises image generation room labels, and different image generation rooms correspond to different usage scene information;
in response to a selection operation for a target image generation room on the image generation room selection page, displaying an image generation prompt information configuration page corresponding to the target image generation room; and
determining usage scene information corresponding to the target image generation room as the target usage scene information;
wherein generating the target image based on the extended text comprises: generating the target image based on the extended text in the target image generation room.

13. The electronic device according to claim 9, wherein each of the plurality of extension aspects has a corresponding preset lexical database; and extending the original text according to the plurality of extension aspects included in the target extension template to obtain the extended text, comprises:
for an extension aspect of the plurality of extension aspects, extracting a first reference text related to the extension aspect from the original text; determining a second reference text related to the extension aspect from the preset lexical database; and performing extension based on the first reference text and/or the second reference text to obtain description information corresponding to the extension aspect; and
organizing description information corresponding to respective extension aspects to obtain the extended text.

14. The electronic device according to claim 13, wherein extracting the first reference text related to the extension aspect from the original text comprises:
performing semantic understanding on the original text to obtain a semantic understanding result; and
extracting the first reference text related to the extension aspect from the original text based on the semantic understanding result.

15. The electronic device according to claim 13, wherein organizing the description information corresponding to the respective extension aspects to obtain the extended text comprises:
organizing the description information corresponding to the respective extension aspects according to a preset arrangement order to obtain the extended text.

16. The electronic device according to claim 13, wherein the image generation method further comprises:
displaying description information corresponding to the extension aspect; and
in response to a modification instruction to modify the description information corresponding to the extension aspect, updating the extended text based on description information corresponding to the extension aspect that has been modified according to the modification instruction;
wherein generating the target image based on the extended text comprises:
generating the target image based on the extended text that has been updated.

17. A computer-readable storage medium having a computer program stored thereon, the computer program, when executed by a processor, implements an image generation method, comprising:
obtaining an original text;
determining a target extension template, wherein the target extension template comprises a plurality of extension aspects;
extending the original text according to the plurality of extension aspects included in the target extension template to obtain an extended text; and
generating a target image based on the extended text.

18. The computer-readable storage medium according to claim 17, wherein determining the target extension template comprises:
determining target usage scene information; and
determining the target extension template based on the target usage scene information.

19. The computer-readable storage medium according to claim 18, wherein determining the target usage scene information comprises:
displaying an image generation information configuration page, wherein the image generation information configuration page comprises image generation model labels, and different image generation model labels correspond to different image generation models, each image generation model has corresponding usage scene information; and
in response to a selection operation for a target image generation model on the image generation information configuration page, determining usage scene information corresponding to the target image generation model as the target usage scene information;
wherein generating the target image based on the extended text comprises: inputting the extended text into the target image generation model to obtain the target image.

20. The computer-readable storage medium according to claim 18, wherein determining the target usage scene information comprises:
displaying an image generation room selection page, wherein the image generation room selection page comprises image generation room labels, and different image generation rooms correspond to different usage scene information;
in response to a selection operation for a target image generation room on the image generation room selection page, displaying an image generation prompt information configuration page corresponding to the target image generation room; and
determining usage scene information corresponding to the target image generation room as the target usage scene information;
wherein generating the target image based on the extended text comprises: generating the target image based on the extended text in the target image generation room.
